(19) United States
(12) Patent Application Publication
(10) Pub. No.: US 2009/0084384 A1
(43) Pub. Date: Apr. 2, 2009

(54) FACE MASK STRUCTURE

(75) Inventors: Y. J. Cheng, Taipei City (TW); Su-Yu Sen, Taipei (TW)

Correspondence Address: CENTER HEALTHCARE TECHNOLOGY CO., LTD., P.O.BOX 108-00403, Taipei, 106, omitted

(73) Assignee: CENTER HEALTHCARE TECHNOLOGY CO., LTD., Taipei City (TW)

(21) Appl. No.: 12/211,822

(22) Filed: Sep. 17, 2008

(30) Foreign Application Priority Data
Sep. 27, 2007 (TW) 096216143
Nov. 2, 2007 (TW) 096218527

(51) Int. Cl. A62B 18/00

(52) U.S. Cl. 128/206.19

(57) ABSTRACT

A face mask structure, which includes an outer protective layer prepared from a water-repellent non-woven fabric; an inner protective layer prepared from a hydrophile non-woven fabric; a filter layer prepared from a static high-density fiber material for filtering microbes and dust powder, and sandwiched between the outer and inner protective layers; and a compound layer treated with a multiple functionalize carboxylic acid derivative that is a product from a chemical reaction between a cyclodextrin complex and a multiple functionalize carboxylic acid. The cyclodextrin complex can be a complex of cyclodextrin and an essential oil, antibiotic agent, or mosquito repellent agent.

This application claims the priority benefit of Taiwan patent application numbers 096216143 filed on Sep. 27, 2007 and 096218527 filed on Nov. 2, 2007 respectively.

### BACKGROUND OF THE INVENTION

1. Field of the Invention

The present invention relates to a face mask, and more particularly, to a face mask structure having contained therein compound layer(s); which the compound layers are created by treating the fabric with a compound using a nano-mapping technique that uses a multiple functionalize carboxylic acid as a bridging agent; the compound is applied onto the fabric using the nano-mapping technique and the multiple functionalize carboxylic acid allows for a graft reaction to happen between the compound and the fiber; and the treatment alters the quality of the fabric, providing for the functions of absorbing water, eliminating odor, releasing of aromatic smell, killing microbes, and/or repelling insects.

2. Description of the Related Art

After the outbreak of severe acute respiratory syndrome (SARS), people are paying more attention to both personal hygiene and environmental cleanliness. They realize that microbes and viruses exist in the air all around them. Because bacteria and virus can easily be transmitted from one person to another via contact or body fluid (such as spit droplets), people have to pay more attention to their personal hygiene to protect themselves. This is especially important to healthcare workers. As a place filled extensively with microbes and viruses, hospitals themselves pose a threat to the people who work within them. In this case, healthcare workers normally wear a face mask that provides filtration to the air they breathe as well as the air they breathe out, and they wash their hands before and after their contact with any patient. As for food process workers, they do not need to mind their hygiene so much as for their own sake but rather for the consumers. People who work in food production lines or a restaurant normally will also wear a face mask, but for preventing contamination of the food they handle. A motorcyclist may also want to wear a face mask. They do so to prevent inhalation of toxic gas when they are riding on their motorcycle.

When a person is wearing a face mask, actions such as yawning, talking or sneezing tend to cause saliva to shoot from the person's mouth onto the inner surface of the face mask. Once onto the face mask, saliva tends to stick on the face mask and create a bad smell. The smell is especially exaggerated when the wearer inhales. Furthermore, even while wearing a brand new face mask, a person working in a hospital can still be irritated by a variety of smells. Bad smells such as those coming from disinfecting solution may cause any person to feel uncomfortable, leading to even vomit or faint. In general, regular face masks have the following drawbacks:

1. A non-woven fabric type medical face mask is a good face mask for breathing. However, it may release a plastic smell coming from the polymeric material making up the non-woven fabric. The plastic smell may cause the user to feel uncomfortable.

2. A medical face mask made out of cotton does not release any plastic smell. However, its filtration effect is inferior to that of a non-woven fabric type medical face mask. In addition, it cannot eliminate adhesion and accumulation of saliva on the cotton fiber, which leads to another bad smell.

3. Commercial disposable face masks cannot effectively absorb or eliminate bad smell in the air. Even if one is wearing multiple face masks at the same time, the face masks still cannot keep the wearer from smelling the bad smells.

Therefore, it is desirable to provide a face mask structure that eliminates the aforesaid problems.

### SUMMARY OF THE INVENTION

The present invention has been accomplished with the circumstances in view. It is therefore the main object of the present invention to provide a face mask structure with the functions of absorbing water, eliminating odor, releasing of aromatic smell, killing microbes, and/or repelling insects.

To achieve this and other objects of the present invention, the face mask structure is comprised of an outer protective layer, prepared from a water-repellent non-woven fabric; an inner protective layer, prepared from a hydrophile non-woven fabric; at least one filter layer, prepared a static high-density fiber material for filtering microbes and dust powder, and sandwiched between the outer protective layer and the inner protective layer; and a compound layer set in between the outer protective layer and the inner protective layer. The compound layer is prepared using a multiple functionalize carboxylic acid derivative that is the product from a chemical reaction between cyclodextrin complex and a multiple functionalize carboxylic acid. The cyclodextrin complex can be a complex of cyclodextrin and an essential oil, antibiotic agent, or mosquito repellent agent.

### BRIEF DESCRIPTION OF THE DRAWINGS

FIG. 1 illustrates the outer appearance of a face mask structure in accordance with a first embodiment of the present invention.

FIG. 2 is an exploded view of the face mask structure in accordance with a first embodiment of the present invention.

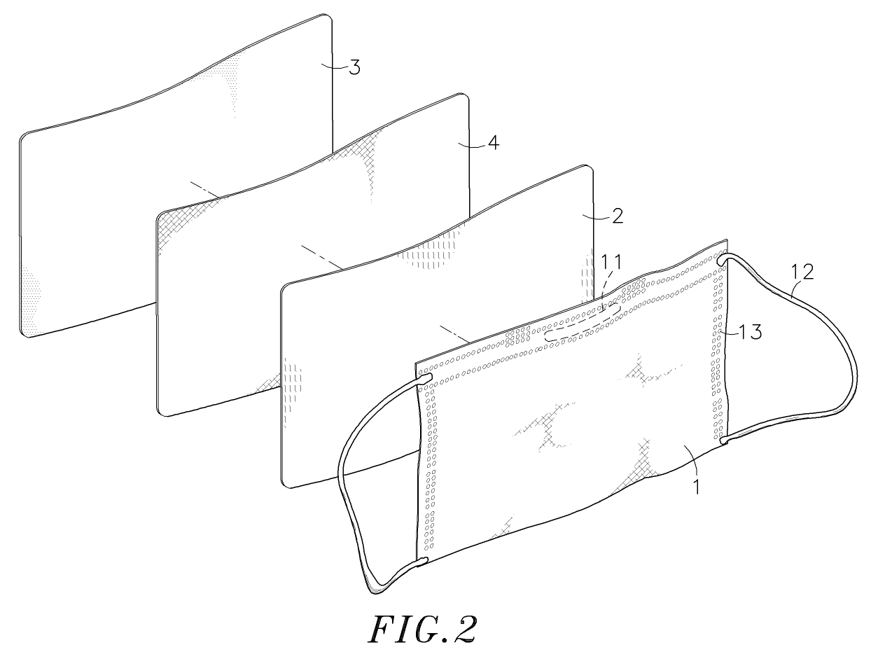

FIG. 3 is a schematic applied view of the first embodiment of the present invention, showing the face mask worn on the face of a person.

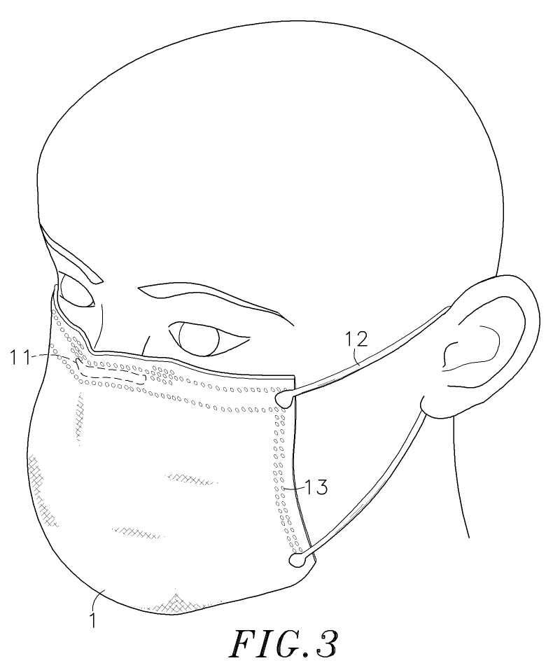

FIG. 4 is a schematic sectional side view corresponding to FIG. 3.

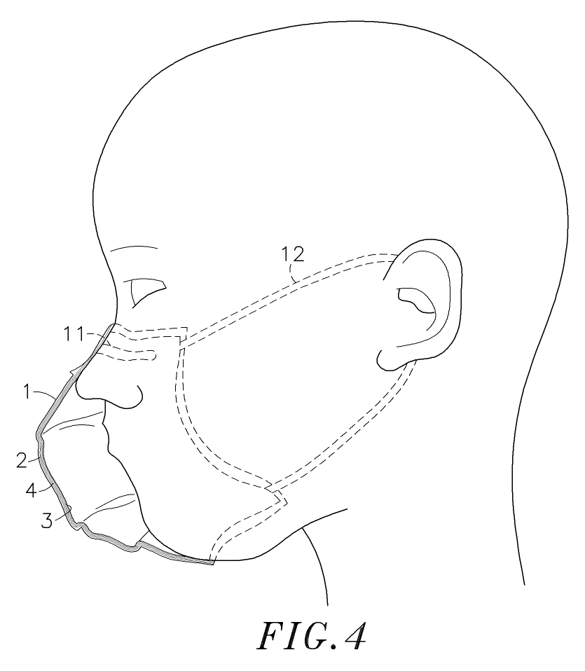

FIG. 5 is a sectional view of a face mask structure in accordance with a second embodiment of the present invention.

FIG. 6 is an exploded view of the face mask structure in accordance with the second embodiment of the present invention.

FIG. 7 is a sectional view of a face mask structure in accordance with a third embodiment of the present invention.

### DETAILED DESCRIPTION OF THE PREFERRED EMBODIMENT

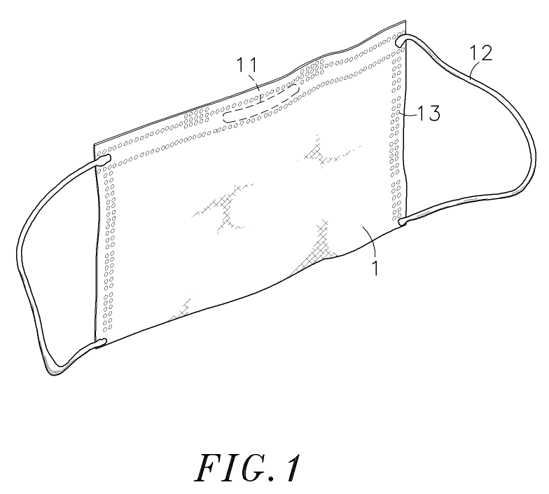

Referring to FIGS. 1˜4, a face mask structure in accordance with a first embodiment of the present invention is shown comprised of an outer protective layer 1, a filter layer 2, an inner protective layer 3, and at least one compound layer 4.

The outer protective layer 1 is made out of a water-repellent non-woven fabric that prohibits the passing through of fluid and dust powder. It has a shape-control nose clip 11 that can be bent into the desired shape for holding the outer protective layer 11 in a particular shape. It also has two ear loops 12 at the two opposite lateral sides, used for securing the outer protective layer 1 to the user's ears.

The filter layer 2 is made out of a static high-density fiber material capable of filtering microbes and dust powder.

The inner protective layer 3 is made out of a hydrophile ultra-fine composite fiber, having soft and water absorptive characteristics.

During the assembly process of the face mask structure, the outer protective layer 1, the filter layer 2 and the inner protective layer 3 are properly arranged in a stack with the compound layer 4 set in between the filter layer 2 and the inner protective layer 3 (or the outer protective layer 1 and the filter layer 2). The border of the outer protective layer 1 and the border of the filter layer 2 and the border of the inner protective layer 3 are fixedly fastened together with, for example, stitches 13.

Unlike ordinary post-aromatic treatments such as conventional micro-encapsulation coating or essential oil coating technique that cannot keep the aromatic effect for long, the present invention uses a treatment that employs a nano-mapping technique to apply a compound to the fiber and a multiple functionalize carboxylic acid as the bridging agent for a graft reaction between the compound and the fiber. The treatment in effect modifies the quality of the fiber, providing for improved persistence to the aromatic effect over that of ordinary treatments.

Further, the compound layer(s) 4 can be bonded in between the outer protective layer 1 and the filter layer 2 and/or in between the filter layer 2 and the inner protective layer 3. Alternatively, the compound layer 4 can be directly synthesized onto the surface of the outer protective layer 1, the filter layer 2, and the inner protective layer 3. When the two ear loops 12 of the outer protective layer 1 are respectively fastened to the user's ears to have the face mask covering over the user's nose and mouth, the shape-control nose clip 11 can be curved to fit over the contour of the user's nose.

When the user is wearing the face mask, the face mask absorbs the nasal drip and other fluid secretion that comes out of the user's nose and mouth, and filters the air exhaled by the user. The exhalation is filtered by the filter layer 2 when it passes through the face mask to the space beyond the face mask. This prevents the accumulation of bad smell at the inner side of the face mask. Furthermore, the filter layer 2, the inner protective layer 3 and the compound layer 4 absorb the moisture that accompanies the gas being inhaled, as they are passing through the face mask from the space beyond. In addition, the compound layer 4 attributes better moisture absorbing performance to the face mask.

The compound layer 4 is prepared using a multiple functionalize carboxylic acid derivative that is a product from a chemical reaction between cyclodextrin complex and the multiple functionalize carboxylic acid. Polyacrylic acid can be one example of the multiple functionalize carboxylic acid. The cyclodextrin complex can be a complex of cyclodextrin and the essential oil. The prepared multiple functionalize carboxylic acid and cyclodextrin complex (the complex of an essential oil and cyclodextrin) are then used to react with polyester, polypropylene, nylon or cellulose fiber fabrics. This attributes to long-term effective performance, allowing compound layer 4 to release aromatic molecules smoothly over an extensively elongated time. The essential oil can be concentrated liquid containing volatile aroma compounds from aromatic herbs or aromatic plants. Alternatively, the essential oil can also be concentrated liquid containing volatile aroma compounds from natural or synthetic substances. The essential oil can also be prepared from medicinal herbs, attributing the face mask with the function of soothing the user's mental spirits and providing relief from nasal catarrh, sinusitis, allergic rhinitis, etc.

Further, the cyclodextrin complex can be a complex of cyclodextrin and an antibiotic agent or mosquito repellent agent. By means of the reaction between the prepared cyclodextrin complex and polyester, polypropylene, nylon or cellulose fiber fabrics, the compound layer 4 provides an antibiotic or mosquito repelling function. Moreover, mosquito repellent agent can be derived from diethyltoluamide, esbiotherin or cyclopropanecarboxylate.

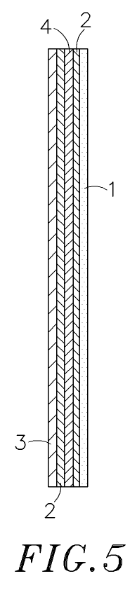

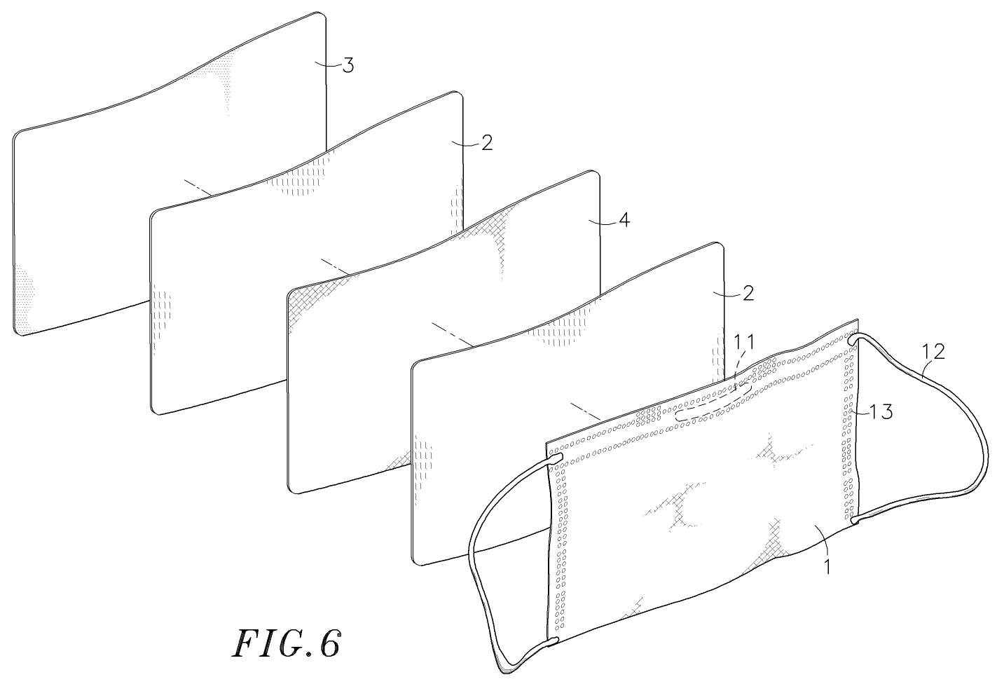

FIGS. 5 and 6 show a face mask structure in accordance with a second embodiment of the present invention. This embodiment is substantially similar to the aforesaid first embodiment, but with the exception that the two filter layers 2 are set instead between the outer protective layer 1 and the inner protective layer 3, and the compound layer 4 is set instead between the two filter layers 2.

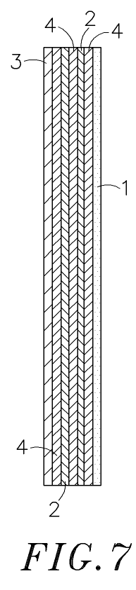

FIG. 7 shows a face mask structure in accordance with a third embodiment of the present invention. According to this embodiment, the face mask structure is comprised of an outer protective layer 1; an inner protective layer 3; two filter layers 2 set between the outer protective layer 1 and the inner protective layer 3; and three compound layers 4 with one set between the outer protective layer 1 and the adjacent filter layer 2, one set between the two filter layers 2, and one set between the inner protective layer 3 and the adjacent filter layer 2.

As stated above, the invention provides a face mask structure comprised of an outer protective layer 1, an inner protective layer 3, at least one filter layer 2 set between the outer protective layer 1 and the inner protective layer 3, and at least one compound layers 4 also set between the outer protective layer 1 and the inner protective layer 3. The face mask structure has the following advantages in its features:

1. The compound layer 4 is prepared from a multiple functionalize carboxylic acid derivative that is a product from a chemical reaction between a cyclodextrin complex and a multiple functionalize carboxylic acid. The cyclodextrin complex can be a complex of cyclodextrin and an essential oil, antibiotic agent, or mosquito repellent agent. The compound layer 4 releases aromatic molecules, providing for a persistent aromatic effect.

2. The compound layer 4 admits air, and works with the filter layer 2 to remove the moisture and solid matters that accompanies the gas passing through the face mask, protecting the user from the moisture and solid matter which may pose a threat.

3. The composition of the compound layer 4 has moisture absorbing and aromatic molecule releasing characteristics, improving the practicality of the face mask.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A face mask structure comprising
an outer protective layer prepared from a water-repellent non-woven fabric;
an inner protective layer prepared from a hydrophile non-woven fabric;
at least one filter layer prepared from a static high-density fiber material for filtering microbes and dust powder, and sandwiched between said outer protective layer and said inner protective layer; and
at least one compound layer set in between said outer protective layer and said inner protective layer;
wherein said at least one compound layer is prepared from a multiple functionalize carboxylic acid derivative that is a product from a chemical reaction between a multiple functionalize carboxylic acid bridging agent and a fiber compound.

2. The face mask structure as claimed in claim 1, wherein said at least one compound layer is set between said outer protective layer and said at least one filter layer.

3. The face mask structure as claimed in claim 1, wherein said at least one compound layer is set between said inner protective layer and said at least one filter layer.

4. The face mask structure as claimed in claim 1, wherein said at least one compound layer is set between said outer protective layer and said at least one filter layer and between said inner protective layer and said at least one filter layer.

5. The face mask structure as claimed in claim 1, wherein said fiber compound is prepared from one of polyester, polypropylene, nylon and cellulose fiber fabrics.

6. The face mask structure as claimed in claim 1, wherein said fiber compound is treated with a product from a chemical reaction between cyclodextrin complex and a multiple functionalize carboxylic acid; said multiple functionalize carboxylic acid being selected from one of citric acid and polyacrylic acid; said cyclodextrin complex being prepared from cyclodextrin and an essential oil; and said fiber compound being prepared from one of polyester, polypropylene, nylon and cellulose fiber fabrics.

7. The face mask structure as claimed in claim 1, wherein said fiber compound is treated with a product from a chemical reaction between a cyclodextrin complex and a multiple functionalize carboxylic acid; said multiple functionalize carboxylic acid being selected from one of citric acid and polyacrylic acid; said cylodextrin complex being prepared from cyclodextrin and a medical compound; and said fiber compound being prepared from one of polyester, polypropylene, nylon and cellulose fiber fabrics.

8. The face mask structure as claimed in claim 1, wherein said fiber compound is treated with a product from a chemical reaction between a cyclodextrin complex and a; said multiple functionalize carboxylic acid being selected from one of citric acid and polyacrylic acid; said cylodextrin complex being prepared from cyclodextrin and one of an antibiotic agent and a mosquito repellent agent; and said fiber compound being prepared from one of polyester, polypropylene, nylon and cellulose fiber fabrics.

9. A face mask structure comprising
an outer protective layer prepared from a water-repellent non-woven fabric;
an inner protective layer prepared from a hydrophile non-woven fabric;
at least one filter layer prepared from a static high-density fiber material for filtering microbes and dust powder, and sandwiched between said outer protective layer and said inner protective layer;
wherein a compound layer is coated on the surface(s) of any, a combination, or all of said layers, which include said outer protective layer, said inner protective layer, and said at least one filter layer, with said compound layer being prepared from a multiple functionalize carboxylic acid derivative that is a product from a chemical reaction between a multiple functionalize carboxylic acid bridging agent and a fiber compound.

10. The face mask structure as claimed in claim 9, wherein said fiber compound is prepared from one of polyester, polypropylene, nylon, and cellulose fiber fabrics.

11. The face mask structure as claimed in claim 9, wherein said fiber compound is treated with a product from a chemical reaction between a cyclodextrin complex and a multiple functionalize carboxylic acid; said multiple functionalize carboxylic acid being selected from one of citric acid and polyacrylic acid; said cylodextrin complex being prepared from cyclodextrin and an essential oil; and said fiber compound being prepared from one of polyester, polypropylene, nylon and cellulose fiber fabrics.

12. The face mask structure as claimed in claim 9, wherein said fiber compound is treated with a product from a chemical reaction between a cyclodextrin complex and a multiple functionalize carboxylic acid; said multiple functionalize carboxylic acid being selected from one of citric acid and polyacrylic acid; said cylodextrin complex being prepared from cyclodextrin and a medical compound; and said fiber compound being prepared from one of polyester, polypropylene, nylon and cellulose fiber fabrics.

13. The face mask structure as claimed in claim 9, wherein said fiber compound is treated with a product from a chemical reaction between a cyclodextrin complex and a; said multiple functionalize carboxylic acid being selected from one of citric acid and polyacrylic acid; said cylodextrin complex being prepared from cyclodextrin and one of an antibiotic agent and a mosquito repellent agent; and said fiber compound being prepared from one of polyester, polypropylene, nylon and cellulose fiber fabrics.
